(19) United States
(12) Patent Application Publication
(10) Pub. No.: US 2025/0388411 A1
(43) Pub. Date: Dec. 25, 2025

(54) SCRAPER CONVEYOR STRAIGHTENING METHOD BASED ON ROLLING TIME-DOMAIN CONTROL CONCEPT

(71) Applicant: TAIYUAN UNIVERSITY OF TECHNOLOGY, Taiyuan (CN)

(72) Inventors: Jiacheng XIE, Taiyuan (CN); Suhua LI, Taiyuan (CN); Xuewen WANG, Taiyuan (CN); Kun LIU, Taiyuan (CN); Jie ZHANG, Taiyuan (CN); Kai MA, Taiyuan (CN); Xiaoting WANG, Taiyuan (CN); Yuke SONG, Taiyuan (CN); Ziying ZHENG, Taiyuan (CN); Yirong WANG, Taiyuan (CN)

(21) Appl. No.: 19/173,154

(22) Filed: Apr. 8, 2025

(30) Foreign Application Priority Data
Jun. 21, 2024 (CN) 202410806343.0

(51) Int. Cl. B65G 43/00; B65G 45/14

(52) U.S. Cl. CPC B65G 43/00; B65G 45/14

(57) ABSTRACT

This application provides a scraper conveyor straightening method based on a rolling time-domain control concept. The scraper conveyor straightening method includes an execution space, a deduction space, and a prediction space. The method includes: receiving, by the execution space, an optimal propelling strategy of a scraper conveyor finally determined by the prediction space; controlling, by an electro-hydraulic control system, a subsequent propelling operation on the scraper conveyor based on the optimal propelling strategy, so as to achieve a purpose of straightening the scraper conveyor; and at the same time, feeding back real-time mining face information to the deduction space; deducing, by the deduction space, the real-time mining face information, and sending the deduced information to the prediction space; and, receiving, by the prediction space, the deduced information of the deduction space, and performing simulated prediction to finally determine an optimal propelling strategy of the scraper conveyor.

### CROSS REFERENCE TO RELATED APPLICATION

This patent application claims the benefit and priority of Chinese Patent Application No. 2024108063430, filed with the China National Intellectual Property Administration on Jun. 21, 2024, the disclosure of which is incorporated by reference herein in its entirety as part of the present application.

### TECHNICAL FIELD

The present disclosure relates to the field of coal mining process control in a fully-mechanized mining face in an underground coal mine, and in particular, to a scraper conveyor straightening method based on rolling time-domain control concept.

### BACKGROUND

The scraper conveyor is a critical component of a fully-mechanized mining face in a coal mine. During coal mining operations performed by three coordinated machines, the scraper conveyor not only serves as an operating track of a coal mining machine but also plays an important role in transporting the coal cut and obtained by the mining machine. In addition, the scraper conveyor is connected to a plurality of hydraulic supports, based on which an advancing operation can be performed. Adjusting the position and pose of the scraper conveyor based on the straightness can prevent a material from being blocked during transportation, thereby improving the production efficiency of the coal mine. In addition, straightening the scraper conveyor can greatly avoid faults and wear of equipment, thereby greatly reducing the maintenance time of the equipment, improving the safety of the operating environment, and reducing the labor intensity and accident risks of the staff.

The patent document with application number CN108518237A discloses a method for straightening a scraper conveyor based on an effective advancing stroke of a hydraulic support, in which a relevant sensor is placed on each hydraulic support and the controllers of all the hydraulic supports are connected together. A hydraulic support is randomly selected, and an effective propelling displacement of the hydraulic support is obtained by using a pressure sensor and a displacement sensor. The effective propelling displacement of this hydraulic support is used as an expected value. Other hydraulic supports are controlled to perform propelling operations based on this expected value. The effective propelling displacement obtained after the propelling operation is compared with the expected value. Adjustments are made again based on the comparison result. Finally, the deviation of each hydraulic support propelled is reduced, thereby ensuring the straightness of the scraper conveyor.

The patent document with application number CN105000328A discloses an apparatus and method for automatically straightening a body of a scraper conveyor in a fully-mechanized mining face, in which an elastic rod is installed between two adjacent hydraulic supports. An angle sensor is installed between the elastic rod and the hydraulic support. An elastic connector is installed between two adjacent sections of line pans of the scraper conveyor. A strain sensor capable of reflecting temperature compensation is installed in the elastic connector. The angle sensor is connected to the strain sensor by using an information processing system. Communication between the information processing system and an electro-hydraulic control system is established by using a data transmission module. The positioning of the hydraulic support and the straightening operation of the line pan of the scraper conveyor are performed based on the voltage signal received by the electro-hydraulic control system. On this basis, the hydraulic support and the scraper conveyor are controlled to perform related actions according to actual conditions.

The patent document with application number CN114647942A provides a scraper conveyor straightening method, an electronic device, and a storage medium, in which the trajectory of a coal mining machine that cuts a coal wall is obtained. The corresponding scraper conveyor trajectory is calculated, and then the corresponding scraper conveyor trajectory is compared with a reference straight line perpendicular to the advancing direction of the mining face. Based on the comparison result between the scraper conveyor trajectory corresponding to the previous cut of the coal wall by the coal mining machine and the reference straight line, a displacement compensation value at each propelling point in the scraper conveyor trajectory corresponding to the current cut of coal wall by the coal mining machine is calculated. In the current cut of the coal wall, each propelling point is compensated based on the displacement compensation value of the propelling point. Benchmarked against the scraper conveyor, the advancing distance of the current scraper conveyor is determined based on a previous scraper conveyor trajectory, thereby performing a straightening operation.

However, the above method exhibits the following disadvantages:

(1) The effective propelling displacement obtained after the propelling operation is compared with the expected value. During the propelling, only the propelling process of the scraper conveyor is considered. In an actual propelling process, due to the change in the coal seam floor, some line pans of the scraper conveyor may fail to complete the propelling process. The method is inconsistent with the actual propelling situation.

(2) Under actual mining conditions, due to the unpredictable changes in the coal seam floor, especially the dynamic changes during the cutting process, the adjustment of the scraper conveyor and the hydraulic support performed by use of an electro-hydraulic control system alone may make the adjustment impracticable in some stages of the advancing process during operations due to changes in the form of the floor.

(3) The obtaining of the scraper conveyor trajectory involves back-calculation of the information after one cutting pass of the coal mining machine, and then the straightening operation is performed based on the information on the scraper conveyor trajectory. Due to the lag in information, it is impracticable to implement single-cut straightening.

### SUMMARY

In order to solve the problems in the existing scraper conveyor straightening method such as inability to implement straightening due to omission of considering the dynamic change in the form of the coal seam floor, and inability to implement single-cut straightening due to information lag, the present disclosure provides a scraper conveyor straightening method based on a rolling time-domain control concept.

The present disclosure is implemented through the following technical solutions: a scraper conveyor straightening method based on a rolling time-domain control concept, including the following spaces: an execution space containing a feedback control model, a deduction space containing a mining face information processing model, and a prediction space containing a coupled floor update model, a baseline prediction model, a spatial difference feedback model, and a control quantity optimization model, where the method includes:
receiving, by the feedback control model of the execution space, an optimal propelling strategy of a scraper conveyor finally determined by the prediction space; controlling, by an electro-hydraulic control system, a subsequent propelling operation on the scraper conveyor based on the optimal propelling strategy, so as to achieve a purpose of straightening the scraper conveyor; and at the same time, feeding back real-time mining face information to the mining face information processing model of the deduction space;
deducing and back-calculating (briefly referred to as deducing), by the mining face information processing model in the deduction space, the real-time mining face information fed back by the execution space feedback control model that has been run, and sending the deduced information (that is, results of the deduction and back-calculation) to the prediction space, where the real-time mining face information includes pose information of three fully-mechanized mining machines, cutting information of a coal mining machine, coal seam floor information, and the like;
receiving, by the prediction space, the deduced information of the deduction space, and performing simulated prediction to finally determine an optimal propelling strategy of the scraper conveyor, where the coupled floor update model constructs a virtual known coal seam floor based on the deduced information, establishes a coupling relationship between fully-mechanized mining equipment and the coal seam floor, and finally predicts and updates a coal seam floor model of a to-be-mined region;
simulating, by the baseline prediction model, a scraper conveyor propelling process based on the coupled floor update model, predicting a scraper conveyor baseline after a propelling operation, and providing a calculation basis for the subsequent spatial difference feedback model and the control quantity optimization model;
providing, by the spatial difference feedback model, correction data for equipment pose adjustment of the subsequent control quantity optimization model, where the spatial difference means a spatial difference between actual pose information of the scraper conveyor after a current propelling operation (that is, at a current cut) and a post-propelling scraper conveyor baseline previously predicted by the baseline prediction model (that is, at a previous cut); and
obtaining, by the control quantity optimization model, the optimal propelling strategy based on the coupled floor update model, the baseline prediction model, and the spatial difference feedback model, and providing the optimal propelling strategy to the feedback control model of the execution space.

The mining face information processing model obtains the pose information of the three fully-mechanized mining machines according to the following specific process:
Step 101: A step of obtaining pose information of a hydraulic support group: installing a three-dimensional lidar at a middle position of a body of the coal mining machine and scanning the hydraulic support group along with a cutting process of the coal mining machine; using a pin that connects a base and an advancing cylinder on the hydraulic support and one vertex position at a junction between a top beam and a guard plate as characteristic positions, obtaining point cloud data of the two characteristic positions, and performing filtering, segmentation, and registration operations; and deducing the resultant point cloud data that is relatively accurate, and finally obtaining the pose information of the hydraulic support group;
Step 102: A step of obtaining the pose information of the scraper conveyor: obtaining data of a strapdown inertial navigation system on the coal mining machine; eliminating a cumulative error of the strapdown inertial navigation system by using an extended Kalman filter method, and obtaining accurate position information of the coal mining machine; back-calculating a trajectory of the scraper conveyor by use of the position information of the coal mining machine based on a position relationship between the scraper conveyor and the coal mining machine; and selecting a key point on each section of line pan of the scraper conveyor, and deducing the pose information of the scraper conveyor by using the key point, where the key point is typically a center point of each section of line pan of the scraper conveyor and no special requirement is imposed on selection of the key point; and
Step 103: Data processing step: eliminating abnormal values in the pose information obtained in the step 101 and the step 102; quantizing and storing information data to facilitate subsequent information deduction and update operations.

In addition, the mining face information processing model may obtain the coal mining machine cutting information and the coal seam floor information according to existing known technology.

A specific construction process of the coupled floor update model is:
Step 201: Constructing a virtual coal seam floor: constructing the virtual coal seam floor based on known coal seam floor information obtained by the mining face information processing model, and constructing the virtual coal seam floor by using a Mesh component in Unity3D software;
Step 202: Constructing a coupled relationship model between the virtual coal seam floor and an equipment model: importing the equipment model into the Unity3D software, and setting relevant rigid body components for the equipment model; and adjusting position parameters of the equipment model so that the equipment model is in close fit with the virtual coal seam floor, so as to complete construction of a coupling relationship model between the virtual coal seam floor and the equipment model, where the equipment includes a coal mining machine, a hydraulic support group, and a scraper conveyor;
Step 203: Predicting a corresponding coal seam floor correction model after the scraper conveyor is propelled: predicting, by using a deep long short-term memory (LSTM) neural network method based on the coal mining machine cutting information (the cutting information of a rear drum of the machine when the coal mining machine is cutting) obtained by the mining face information processing model and based on coal drop information of the coal mining machine in past cutting processes, the corresponding coal seam floor correction model after the scraper conveyor is propelled, where the deep LSTM neural network method belongs to the existing known technology, which is a mathematical algorithm model that imitates the behavioral characteristics of the animal nervous system and is used for distributed parallel information processing.
Step 204: Predicting a physical behavior-based coal seam floor update model: setting a scraper conveyor propelling amount based on the coupling relationship model of step 202 and the coal seam floor correction model of step 203, running Unity3D software to simulate a propelling operation of the scraper conveyor, applying SURF algorithm to extract feature point information of the coal seam floor corresponding to a propelling section of the scraper conveyor after the scraper conveyor is propelled, and reconstructing a corresponding coal seam floor after the scraper conveyor is propelled, so as to obtain a reconstructed coal seam floor model; analyzing, based on the reconstructed coal seam floor model, pit and loose coal pile damage caused by a propelling behavior of the scraper conveyor to the coal seam floor (the coal seam floor roughly falls in two circumstances: pits and loose coal piles), performing stress analysis, and obtaining, based on the Mohr-Coulomb criterion, a proof of damage caused to the floor after the scraper conveyor is propelled; performing numerical value simulation analysis on the reconstructed coal seam floor model by using FLAC3D software based on the proof of damage to the floor, and calculating a maximum damage depth and position of the coal seam floor caused by a force along a propelling direction of the scraper conveyor and a lateral support pressure under a stress model; and finally, constructing a physical behavior-based coal seam floor update model by using the Mesh component in the Unity3D software based on the reconstructed coal seam floor model and results of the maximum damage depth and position.

A specific construction process of the baseline prediction model is:
Step 301: Expressing position information of a key point in each section of line pan of the scraper conveyor at the current cut (that is, before propelling) based on a primary coordinate system, where the key point in the line pan is typically a center point of each section of line pan of the scraper conveyor and no special requirement is imposed on selection of the key point in the line pan;
Step 302: Comparing coordinate information of each section of line pan in the propelling direction of the scraper conveyor, determining a most lagging section of line pan, and recording a serial number i of the most lagging section of line pan;
Step 303: Establishing a parallel system in the Unity3D software based on the coal seam floor update model to simulate a propelling process of the scraper conveyor, and obtaining position information of the most lagging section of line pan (that is, the ith section of line pan) that has been advanced for a full stroke (that is, a maximum stroke by which the propelling cylinder of the electro-hydraulic control system of the execution space can advance the line pan);
Step 304: Selecting n position points evenly in the entire advancing stroke of the most lagging section of line pan, numbering the n position points from 1 to n in a direction from a start to an end of advancing, and obtaining position information of each position point;
Step 305: Simulating the propelling process of remaining line pans of the scraper conveyor in the parallel system by using a position line corresponding to the position point n as an end point of the advancing stroke (the position line is a reference straight line that passes through the position point n and that is perpendicular to the propelling direction of the scraper conveyor on the mining face), and determining whether the key points of all the remaining line pans reach the position line corresponding to the position point n; using the position line as a predicted baseline of the propelled scraper conveyor when all the remaining line pans reach the position line; or, selecting, when any one of the remaining line pans fails to reach the position line, a position line corresponding to a previous position point as an end point of the advancing stroke; and repeating the above simulation and determining process until the key points of all the remaining line pans of the scraper conveyor reach the end point of the advancing stroke.

The spatial difference feedback model is formed of three parts: a feedforward space, a feedback space, and a correction mechanism, and a specific construction process of the spatial difference feedback model is:

Step 401: Feedforward space: extracting prediction rules in a prediction process based on a past process of predicting a baseline of the propelled scraper conveyor by the baseline prediction model, deducing possible situations, and taking corresponding measures to eliminate possible deviations in advance. For example, when the slope of the coal seam floor is relatively large, a phenomenon of wobbling up and sliding down will occur, or, in a special terrain, the hydraulic support fails to reach an ideal position, thereby resulting in unsmooth propelling. The prediction rules are summarized. Possible situations can be inferred by just a look at the predicted coal seam floor during the propelling, and then an appropriate measure is selected to eliminate possible deviations.

Step 402: Feedback space: calculating a spatial difference based on the baseline of the propelled scraper conveyor (that is, the post-propelling scraper conveyor pose information predicted before the scraper conveyor is propelled) predicted by the baseline prediction model and actual pose information of the propelled scraper conveyor;

Step 403: Correction mechanism: applying data information, obtained from the feedforward space and the feedback space, to a feedforward space prediction process by using a relevant coefficient, so as to obtain a corrected prediction result; monitoring the feedback data continuously, and making adjustments based on real-time feedback information; and iterating and optimizing the correction mechanism continuously based on feedback results of an actual operation.

A specific construction process of the control quantity optimization model is:
Step 501: Obtaining an initially calculated propulsion control quantity: obtaining, by the mining face information processing model, pose information of the scraper conveyor in a current propelling section (that is, the actual pose information of the scraper conveyor after the previous propulsion and before the current propulsion, briefly referred to as the before-propelling actual pose information); predicting, by the baseline prediction model, a scraper conveyor baseline after a current propulsion (that is, the post-propelling scraper conveyor baseline predicted before propelling, briefly referred to as before-propelling scraper conveyor baseline); and then correcting the predicted scraper conveyor baseline after the current propulsion of the scraper conveyor based on a spatial difference obtained by the spatial difference feedback model; and obtaining the initially calculated propulsion control quantity by calculating a difference between the corrected baseline of the scraper conveyor and pose information of the scraper conveyor in the current propelling section;
Step 502: Floor segmentation: obtaining, based on the initially calculated propulsion control quantity and the physical behavior-based coal seam floor update model predicted in step 204, floor data corresponding to the propelling section of the scraper conveyor and propelling trajectory information of each section of line pan of the propelling section of the scraper conveyor; establishing, based on the floor data, a floor function Z=F(x, y, z) corresponding to a propelling trajectory of each section of line pan in the propelling section of the scraper conveyor, and finding an extreme point of the floor function; letting

$$\frac{\partial F}{\partial x} = 0 , \frac{\partial F}{\partial y} = 0 , \frac{\partial F}{\partial z} = 0 ,$$

working out a point to possibly become an extreme point, and determining whether the point is an extreme point; finally determining the extreme point of the coal seam floor corresponding to the propelling trajectory of each section of line pan in the propelling section of the scraper conveyor; segmenting the coal seam floor in the propelling direction of the propelling section of the scraper conveyor based on the determined extreme point, and at the same time, segmenting the propelling trajectory of each section of line pan in the propelling section of the scraper conveyor by using an optimized discretization method based on the corresponding extreme point, where the optimized discretization method is an existing well-known method, and means a method for discretizing an independent variable and a target variable that are linked together; the target variable in the method of the present disclosure is a coordinate change ΔX of the propulsion control quantity in the propelling direction, and the independent variable is an X coordinate value of the coal seam floor.

Step 503: Performing simulation in Unity3D software to find a real-time advancing position of each section of line pan of the scraper conveyor: establishing a coordinate system based on the advancing mechanism between the scraper conveyor and the hydraulic support, using the propelling direction of the scraper conveyor as an X-axis direction, selecting two points on a advancing lug hole on each section of line pan of the scraper conveyor as key points, where the two points are located on the same side as the scraper conveyor, and obtaining pose information of the two key points, so as to obtain a piece of vector information corresponding to the line pan; performing deduction based on a floating connection mechanism model in an advancing mechanism to deduce coordinates of a contact point in the X-axis direction, where the contact point is a point of contact between a connector pin of a floating connection mechanism and the advancing lug hole in an advancing process; calculating position information of the contact point based on the vector information; and finally, calculating a real-time advancing position of each section of line pan of the scraper conveyor based on the physical behavior-based coal seam floor update model predicted in step 204 and the equipment pose information obtained by the mining face information processing model.

Step 504: Performing simulation in the Unity3D software to complete a propelling operation of an S-shaped curved section of the scraper conveyor: using an existing curved section length calculation method to deduce a section of line pan, in which the propelling section of the scraper conveyor is located, in the S-shaped curved section, and determining the number of sections of line pan before the deduced section and the number of sections of line pan after the deduced section in the curved section (that is, separating a previous curved section from a current curved section); establishing a parent-child relationship of the line pan in the Unity3D software, and setting a limit—that is, a maximum curvature of each section of line pan, and then deducing a required advancing amount of each section of line pan of the corresponding form in the scraper conveyor, and executing a propelling operation of the S-shaped curved section of the scraper conveyor in the Unity3D software.

Step 505: Control quantity screening step: outputting, based on the propelling simulation performed in the Unity3D software in the steps 501-504, segmentation information indicating that a section of line pan of the scraper conveyor fails to complete propelling in the entire advancing process; and determining whether a section fails to complete propelling among all sections of line pans of the scraper conveyor at each moment of the propelling process; eliminating corresponding line pan propulsion control quantity information once a section fails to complete propelling, and repeating the above operations until the segmentation information indicating that each section of line pan in the propelling section of the scraper conveyor successfully completes propelling is obtained and the corresponding line pan propulsion control quantity information is obtained.

Step 506: Constructing a cost function to find a theoretical minimum value: selecting floor feature points based on the floor segmentation in step 502, and constructing the following cost function:

$$J = α {\int }_{0}^{t} {( x ( t ) - {x}_{t} arg et )}^{2} d t + β {\int }_{0}^{t} {u ( t )}^{2} d t \qquad Formula ( 1 )$$

In the formula above, x(t) is a current position of the scraper conveyor; xₜarget is a position of a start point (that is, a segmentation point between two sections) of a corresponding section of the floor; t is a time spent by the scraper conveyor in being propelled to travel the corresponding section of the floor; u(t)² is an acting force of a propelling cylinder in the propelling process; α and β are proportions of a position cost and a behavior cost respectively, satisfying: α=0.7 and β=0.3 because this method focuses on control quantities in the process.

A theoretical minimum value is calculated based on the cost function represented by Formula (1) and based on the propulsion control quantity initially calculated in step 501.

Step 507: Selection of an optimal propulsion control quantity: calculating the cost function under different conditions of a propulsion distance and a propulsion force based on the line pan propulsion control quantity obtained in step 505 and the cost function constructed in step 506, and comparing the cost function with the theoretical minimum value to determine whether the minimum value is reached (that is, the cost function is less than or equal to the minimum value); directly deriving the corresponding line pan propulsion control quantity as an optimal propulsion control quantity when the minimum value is reached, or, re-segmenting the coal seam floor based on the extreme point in step 502 when the minimum value is not reached; adjusting a position of a segmentation point based on the extreme point, and translating toward a start point of propelling to complete re-segmentation; adjusting, based on the re-segmentation of the coal seam floor, the propulsion distance and the propulsion force of the propelling section of the scraper conveyor, repeating the simulation and determining in the steps 502, 505, and 506 in the Unity3D software, and keeping adjustment and optimization until the cost function reaches the minimum value.

Step 508: Formulating an optimal propelling strategy: formulating the optimal propelling strategy based on the optimal propulsion control quantity obtained in step 507; and transmitting the optimal propelling strategy to the feedback control model of the execution space.

The design concept of the method of the present disclosure is to deduce and predict a new form of the coal seam floor and other information immediately after the coal mining machine travels through several hydraulic supports, and then the ideal position information of the scraper conveyor is determined. In this way, the scraper conveyor is controlled to reach the specified position, and all subsequent operations can be completed within the current cut, without information lag, thereby aligning with the rolling time-domain control concept. The rolling time-domain control is a control system concept based on real-time parameter adjustment, and enables dynamical adjustment of a control parameter based on the real-time operating status of the system and external conditions to achieve better performance and robustness.

In the prior art, prediction is performed upon the coal mining machine completing one cut in the existing scraper conveyor straightening method. In contrast to the prior art, the method disclosed herein can perform a prediction operation upon the coal mining machine traveling through several supports, and is propelled based on the resultant predicted position, without information lag, thereby enabling straightening within a single cut pass. In addition, the method disclosed herein considers that the scraper conveyor causes a degree of damage to the coal seam floor during a propelling stroke. Therefore, the method disclosed herein adds a physical behavior template on the basis of existing floor information correction during update of the floor, thereby more truly reflecting the change in the coal seam floor in an actual propelling process, and effectively avoiding the inability to implement the straightening caused by the dynamic change in the form of the coal seam floor during actual straightening control. At the same time, in the propelling process, a circumstance that some line pans fail to reach the advancing stroke during propelling is considered, the propelling process is screened simulatively, and the optimal control quantity that meets the advancing stroke is obtained, thereby being closer to the actual situation and facilitating the straightening of the scraper conveyor.

To sum up, the method disclosed herein is free from information lag and enables straightening within a single cut pass. In addition, the process control is in line with practical situations. The coal seam floor update considers the physical damage to the floor caused by the propelling of the scraper conveyor. The method disclosed herein can efficiently implement straightening of the scraper conveyor based on actual conditions.

### BRIEF DESCRIPTION OF THE DRAWINGS

FIG. 1 is a schematic block diagram of a method according to the present disclosure;

FIG. 2 is a schematic block diagram of a coupled floor update model;

FIG. 3 is a schematic block diagram of a baseline prediction model;

FIG. 4 is a schematic block diagram of a control quantity optimization model; and

FIG. 5 is a schematic diagram of a position of a contact point between a connector of a floating connection mechanism and a connecting hole of an advancing lug seat of a line pan during advancement.

In the drawings: 1, 2—key points; 3—connector pin of a floating connection mechanism; 4—contact point; 5—line pan; 6—advancing lug hole.

### DETAILED DESCRIPTION OF THE EMBODIMENTS

The technical solution of the present disclosure is further described below with reference to accompanying drawings and specific embodiments. All other embodiments derived by a person of ordinary skill in the art based on the embodiments of the present disclosure without making any creative efforts fall within the protection scope of the present disclosure.

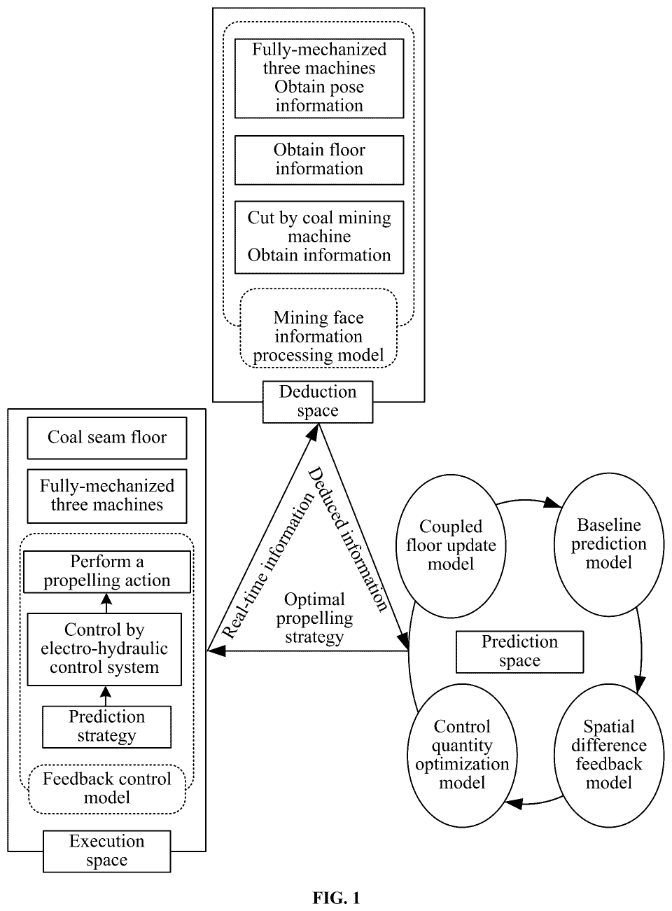

A scraper conveyor straightening method based on a rolling time-domain control concept is disclosed. As shown in FIG. 1, the method includes the following spaces: an execution space containing a feedback control model, a deduction space containing a mining face information processing model, and a prediction space containing a coupled floor update model, a baseline prediction model, a spatial difference feedback model, and a control quantity optimization model, where the method includes:
receiving, by the feedback control model of the execution space, an optimal propelling strategy of a scraper conveyor finally determined by the prediction space; controlling, by an electro-hydraulic control system, a subsequent propelling operation on the scraper conveyor based on the optimal propelling strategy, so as to achieve a purpose of straightening the scraper conveyor; and at the same time, feeding back real-time mining face information to the mining face information processing model of the deduction space;
deducing and back-calculating (briefly referred to as deducing), by the mining face information processing model in the deduction space, the real-time mining face information fed back by the execution space feedback control model that has been run, and sending the deduced information (that is, results of the deduction and back-calculation) to the prediction space, where the real-time mining face information includes pose information of three fully-mechanized mining machines, cutting information of a coal mining machine, coal seam floor information, and the like;
receiving, by the prediction space, the deduced information of the deduction space, and performing simulated prediction to finally determine an optimal propelling strategy of the scraper conveyor, where the coupled floor update model constructs a virtual known coal seam floor based on the deduced information, establishes a coupling relationship between fully-mechanized mining equipment and the coal seam floor, and finally predicts and updates a coal seam floor model of a to-be-mined region;
simulating, by the baseline prediction model, a scraper conveyor propelling process based on the coupled floor update model, predicting a scraper conveyor baseline after a propelling operation, and providing a calculation basis for the subsequent spatial difference feedback model and the control quantity optimization model;
providing, by the spatial difference feedback model, correction data for equipment pose adjustment of the subsequent control quantity optimization model, where the spatial difference means a spatial difference between actual pose information of the scraper conveyor after a current propelling operation (that is, at a current cut) and a post-propelling scraper conveyor baseline previously predicted by the baseline prediction model (that is, at a previous cut); and
obtaining, by the control quantity optimization model, the optimal propelling strategy based on the coupled floor update model, the baseline prediction model, and the spatial difference feedback model, and providing the optimal propelling strategy to the feedback control model of the execution space.

The mining face information processing model obtains the pose information of the three fully-mechanized mining machines according to the following specific process:
Step 101: A step of obtaining pose information of a hydraulic support group: installing a three-dimensional lidar at a middle position of a body of the coal mining machine and scanning the hydraulic support group along with a cutting process of the coal mining machine; using a pin that connects a base and an advancing cylinder on the hydraulic support and one vertex position at a junction between a top beam and a guard plate as characteristic positions, obtaining point cloud data of the two characteristic positions, and performing filtering, segmentation, and registration operations; and deducing the resultant point cloud data that is relatively accurate, and finally obtaining the pose information of the hydraulic support group;
Step 102: A step of obtaining the pose information of the scraper conveyor: obtaining data of a strapdown inertial navigation system on the coal mining machine; eliminating a cumulative error of the strapdown inertial navigation system by using an extended Kalman filter method, and obtaining accurate position information of the coal mining machine; back-calculating a trajectory of the scraper conveyor by use of the position information of the coal mining machine based on a position relationship between the scraper conveyor and the coal mining machine; and selecting a key point on each section of line pan of the scraper conveyor, and deducing the pose information of the scraper conveyor by using the key point, where the key point is typically a center point of each section of line pan of the scraper conveyor and no special requirement is imposed on selection of the key point; and
Step 103: Data processing step: eliminating abnormal values in the pose information obtained in the step 101 and the step 102; quantizing and storing information data to facilitate subsequent information deduction and update operations.

In addition, the mining face information processing model may obtain the coal mining machine cutting information and the coal seam floor information according to existing known technology.

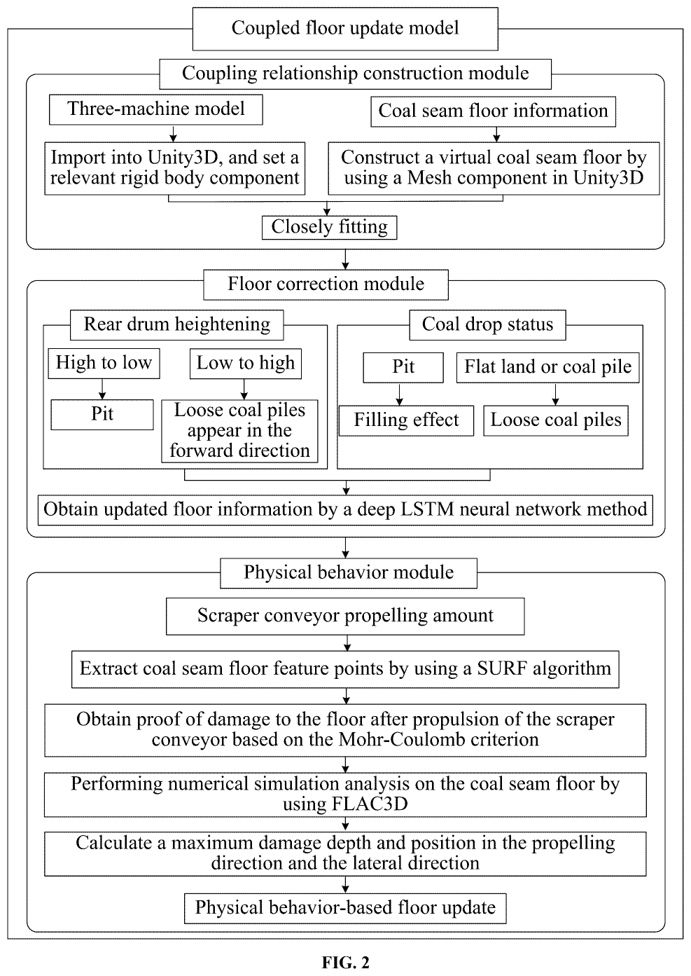

As shown in FIG. 2, a specific construction process of the coupled floor update model is as follows:
Step 201: Constructing a virtual coal seam floor: constructing the virtual coal seam floor based on known coal seam floor information obtained by the mining face information processing model, and constructing the virtual coal seam floor by using a Mesh component in Unity3D software;
Step 202: Constructing a coupled relationship model between the virtual coal seam floor and an equipment model: importing the equipment model into the Unity3D software, and setting relevant rigid body components for the equipment model; and adjusting position parameters of the equipment model so that the equipment model is in close fit with the virtual coal seam floor, so as to complete construction of a coupling relationship model between the virtual coal seam floor and the equipment model, where the equipment includes a coal mining machine, a hydraulic support group, and a scraper conveyor;
Step 203: Predicting a corresponding coal seam floor correction model after the scraper conveyor is propelled: predicting, by using a deep long short-term memory (LSTM) neural network method based on the coal mining machine cutting information (the cutting information of a rear drum of the machine when the coal mining machine is cutting) obtained by the mining face information processing model and based on coal drop information of the coal mining machine in past cutting processes, the corresponding coal seam floor correction model after the scraper conveyor is propelled, where the deep LSTM neural network method belongs to the existing known technology, which is a mathematical algorithm model that imitates the behavioral characteristics of the animal nervous system and is used for distributed parallel information processing.

In this embodiment, a specific process of applying a deep LSTM neural network method to predict the corresponding coal seam floor correction model after propulsion of the scraper conveyor is: feeding input coal mining machine rear drum cutting information at time point t and output coal seam floor update information of the LSTM neural unit at a previous time point into an input gate, a forget gate, and an output gate of the LSTM neural unit simultaneously, and calculating weights of the 3 gates respectively, so as to obtain a value of each gate; modifying memory status of the LSTM neural unit based on the values of the input gate, forget gate, and output gate, and forming a final output of the neural network through an activation function; setting data points at regular intervals to perform data collection and normalization

$${x}_{ij}^{R} = \frac{{x}_{ij} - {x}_{min}}{{x}_{max} - {x}_{min}} ,$$

where xᵢⱼ is a height value of a cutting drum at the j^{th} sampling point in the i^{th} cut, and xₘᵢₙ and xₘₐₓ are a minimum value and a maximum value in the height value data of the cutting drum respectively; dividing the data into a training set and a test set; updating the training set data by using an Adam algorithm; setting an appropriate range of the number of hidden-layer neurons, selecting an appropriate hyperparameter, testing the trained model by using the test set, and recording the error, so as to obtain a more accurate and true coal seam floor correction model.

Step 204: Predicting a physical behavior-based coal seam floor update model: setting a scraper conveyor propelling amount based on the coupling relationship model of step 202 and the coal seam floor correction model of step 203, running Unity3D software to simulate a propelling operation of the scraper conveyor, applying SURF algorithm to extract feature point information of the coal seam floor corresponding to a propelling section of the scraper conveyor after the scraper conveyor is propelled, and reconstructing a corresponding coal seam floor after the scraper conveyor is propelled, so as to obtain a reconstructed coal seam floor model; analyzing, based on the reconstructed coal seam floor model, pit and loose coal pile damage caused by a propelling behavior of the scraper conveyor to the coal seam floor (the coal seam floor roughly falls in two circumstances: pits and loose coal piles), performing stress analysis, and obtaining, based on the Mohr-Coulomb criterion, a proof of damage caused to the floor after the scraper conveyor is propelled; performing numerical value simulation analysis on the reconstructed coal seam floor model by using FLAC3D software based on the proof of damage to the floor, and calculating a maximum damage depth and position of the coal seam floor caused by a force along a propelling direction of the scraper conveyor and a lateral support pressure under a stress model; and finally, constructing a physical behavior-based coal seam floor update model by using the Mesh component in the Unity3D software based on the reconstructed coal seam floor model and results of the maximum damage depth and position.

In this embodiment, a specific process of applying a SURF algorithm to extract feature point information of the coal seam floor corresponding to the propelling section of the scraper conveyor after propulsion of the scraper conveyor is: performing imaging on the coal seam floor based on the virtual coal seam floor constructed by a Mesh component in the Unity3D software, and based on a coupling relationship model between the virtual coal seam floor and an equipment model; and extracting key feature points in the image by using difference of Gaussian function (DoG) and Laplace transform of Gaussian function (LoG). The LoG is approximated by use of a box filter in the SURF to obtain an integral image. Assuming that an image is f(x,y), feature points are extracted by using a Hessian matrix. The corresponding Hessian matrix is:

$$H ( f ( x , y ) ) = [ \begin{matrix}\frac{{\partial }^{2} f}{\partial {x}^{2}} & \frac{{\partial }^{2} f}{\partial x \partial y} \\ \frac{{\partial }^{2} f}{\partial x \partial y} & \frac{{\partial }^{2} f}{\partial {y}^{2}}\end{matrix} ]$$

Gaussian filtering and denoising are performed on the processed image. An image pyramid is established to perform multi-dimensional description. After the position of the point of interest is obtained and the image pyramid is established, feature points are located in the points of interest. First, a suitable threshold needs to selected. The points with the strongest response among the points of interest are retained. The larger the selected threshold, the more feature points will be retained. Subsequently, pixels are compared based on non-maximum suppression. Finally, cubic linear interpolation calculation is performed on the selected key points to obtain stable feature points. According to the feature points, the corresponding coal seam floor after propulsion of the scraper conveyor is reconstructed based on the feature points to obtain a reconstructed coal seam floor model.

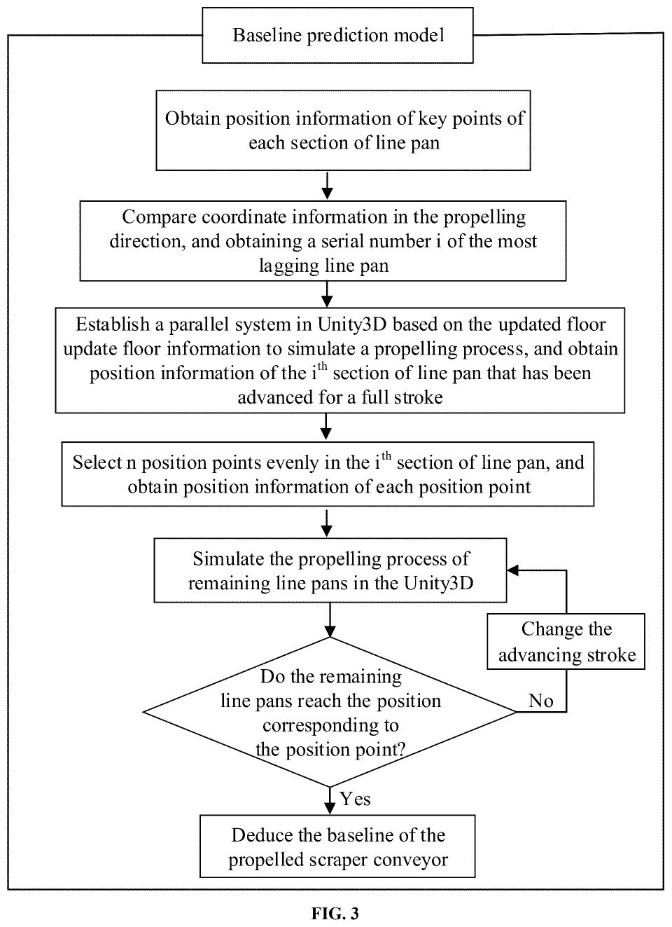

As shown in FIG. 3, a specific construction process of the baseline prediction model is as follows:
Step 301: Expressing position information of a key point in each section of line pan of the scraper conveyor at the current cut (that is, before propelling) based on a primary coordinate system, where the key point in the line pan is typically a center point of each section of line pan of the scraper conveyor and no special requirement is imposed on selection of the key point in the line pan;
Step 302: Comparing coordinate information of each section of line pan in the propelling direction of the scraper conveyor, determining a most lagging section of line pan, and recording a serial number i of the most lagging section of line pan;
Step 303: Establishing a parallel system in the Unity3D software based on the coal seam floor update model to simulate a propelling process of the scraper conveyor, and obtaining position information of the most lagging section of line pan (that is, the i^{th} section of line pan) that has been advanced for a full stroke (that is, a maximum stroke by which the propelling cylinder of the electro-hydraulic control system of the execution space can advance the line pan);
Step 304: Selecting n position points evenly in the entire advancing stroke of the most lagging section of line pan, numbering the n position points from 1 to n in a direction from a start to an end of advancing, and obtaining position information of each position point;
Step 305: Simulating the propelling process of remaining line pans of the scraper conveyor in the parallel system by using a position line corresponding to the position point n as an end point of the advancing stroke (the position line is a reference straight line that passes through the position point n and that is perpendicular to the propelling direction of the scraper conveyor on the mining face), and determining whether the key points of all the remaining line pans reach the position line corresponding to the position point n; using the position line as a predicted baseline of the propelled scraper conveyor when all the remaining line pans reach the position line; or, selecting, when any one of the remaining line pans fails to reach the position line, a position line corresponding to a previous position point as an end point of the advancing stroke; and repeating the above simulation and determining process until the key points of all the remaining line pans of the scraper conveyor reach the end point of the advancing stroke.

The spatial difference feedback model is formed of three parts: a feedforward space, a feedback space, and a correction mechanism, and a specific construction process of the spatial difference feedback model is:

Step 401: Feedforward space: extracting prediction rules in a prediction process based on a past process of predicting a baseline of the propelled scraper conveyor by the baseline prediction model, deducing possible situations, and taking corresponding measures to eliminate possible deviations in advance. For example, when the slope of the coal seam floor is relatively large, a phenomenon of wobbling up and sliding down will occur, or, in a special terrain, the hydraulic support fails to reach an ideal position, thereby resulting in unsmooth propelling. The prediction rules are summarized. Possible situations can be inferred by just a look at the predicted coal seam floor during the propelling, and then an appropriate measure is selected to eliminate possible deviations.

Step 402: Feedback space: calculating a spatial difference based on the baseline of the propelled scraper conveyor (that is, the post-propelling scraper conveyor pose information predicted before the scraper conveyor is propelled) predicted by the baseline prediction model and actual pose information of the propelled scraper conveyor;

In this embodiment, a quaternion method is applied to represent the post-propelling scraper conveyor baseline p predicted by the baseline prediction model and the actual pose information q of the propelled scraper conveyor. The quaternion is converted into an axis angle form, and the result is a spatial difference between the predicted post-propelling scraper conveyor baseline and the actual pose information of the propelled scraper conveyor.

Step 403: Correction mechanism: applying data information, obtained from the feedforward space and the feedback space, to a feedforward space prediction process by using a relevant coefficient, so as to obtain a corrected prediction result; monitoring the feedback data continuously, and making adjustments based on real-time feedback information; and iterating and optimizing the correction mechanism continuously based on feedback results of an actual operation.

In this embodiment, the linear correlation is evaluated by using the Pearson correlation coefficient, and the prediction result is corrected based on the value of the Pearson correlation coefficient. If the correlation coefficient is close to 1, the prediction result is highly correlated with the actual feedback data, and the original prediction result can be maintained. If the correlation coefficient is close to −1, the prediction result is highly negatively correlated with the actual feedback data, and the prediction result needs to be reversely corrected, and the prediction result needs to be proportionally adjusted or corrected in a weighted manner based on the degree of difference between the actual data and the prediction result, so as to reduce the error. If the correlation coefficient is close to 0, no linear relationship exists between the prediction result and the actual feedback data, and a polynomial regression model is applied to introduce the high-order powers of the variables into the regression model to obtain a nonlinear relationship between the prediction result and the actual feedback data.

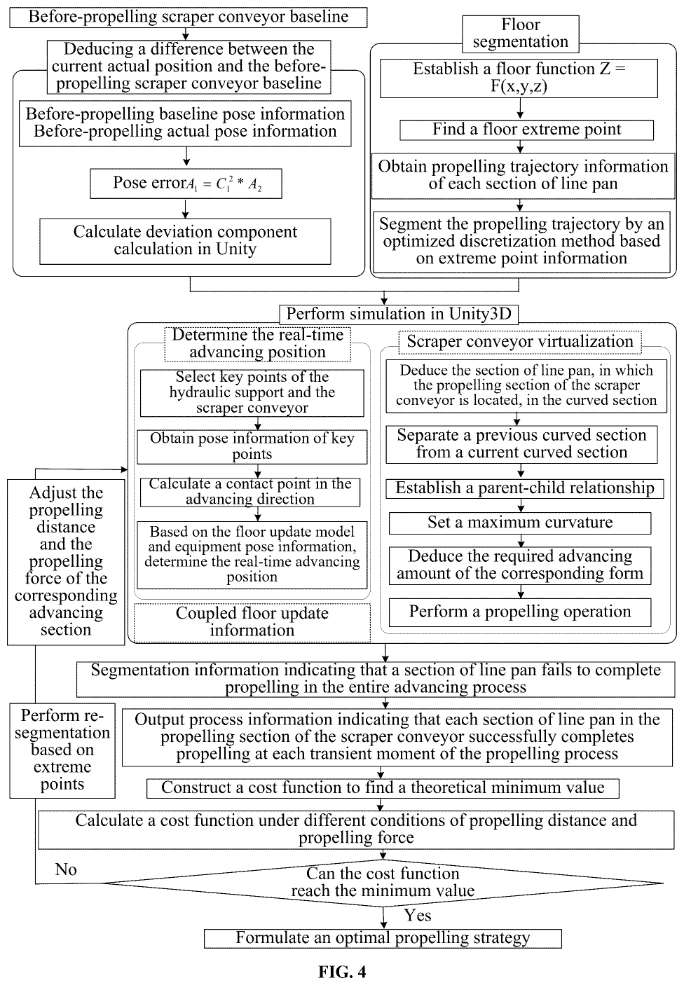

As shown in FIG. 4, a specific construction process of the control quantity optimization model is as follows:

Step 501: Obtaining an initially calculated propulsion control quantity: obtaining, by the mining face information processing model, pose information of the scraper conveyor in a current propelling section (that is, the actual pose information of the scraper conveyor after the previous propulsion and before the current propulsion, briefly referred to as the before-propelling actual pose information); predicting, by the baseline prediction model, a scraper conveyor baseline after a current propulsion (that is, the post-propelling scraper conveyor baseline predicted before propelling, briefly referred to as before-propelling scraper conveyor baseline); and then correcting the predicted scraper conveyor baseline after the current propulsion of the scraper conveyor based on a spatial difference obtained by the spatial difference feedback model; and obtaining the initially calculated propulsion control quantity by calculating a difference between the corrected baseline of the scraper conveyor and pose information of the scraper conveyor in the current propelling section.

In this embodiment, the baseline prediction model predicts the baseline of the scraper conveyor after the current propulsion of the scraper conveyor, and the pose information of the scraper conveyor is denoted as

$${A}_{1} = ( {X}_{h 1}^{( i )} , {Y}_{h 1}^{( i )} , {Z}_{h 1}^{( i )} , {Ψ}_{h 1}^{( i )} , {Φ}_{h 1}^{( i )} , {Θ}_{h 1}^{( i )} ) .$$

The mining face information processing model obtains the pose information of the scraper conveyor in the current propelling section, denoted as

$${A}_{2} = ( {X}_{h 2}^{( i )} , {Y}_{h 2}^{( i )} , {Z}_{h 2}^{( i )} , {Ψ}_{h 2}^{( i )} , {Φ}_{h 2}^{( i )} , {Θ}_{h 2}^{( i )} ) .$$

A pose error is worked out by using the relation

$${A}_{1} = {C}_{1}^{2} * {A}_{2} ,$$

where

$${Ψ}_{h}^{( i )}$$

is yaw angle information of the scraper conveyor;

$${Φ}_{h}^{( i )}$$

is roll angle information of the scraper conveyor;

$${Θ}_{h}^{( i )}$$

is pitch angle information of the scraper conveyor, angle information of the scraper conveyor;

$${C}_{1}^{2}$$

is a rotation matrix from A₁ to A₂. The position error is calculated by applying the CalculateDeviation component in the Unity3D software, where

$${X}_{h}^{( i )} , {Y}_{h}^{( i )} , {Z}_{h}^{( i )}$$

is the position information of the scraper conveyor. Based on the calculated pose error and position error as well as the spatial difference obtained in step 402 by the spatial difference feedback model, a more precise baseline of the scraper conveyor after propulsion is obtained by analytical calculation. Finally, a difference between the corrected scraper conveyor baseline and the pose information of the scraper conveyor in the current propelling section is calculated to obtain a more accurate initially-calculated propulsion control quantity.

In specific implementation, the specific pseudo code for calculating the coordinate difference of X by using the CalculateDeviation component is as follows:

```
public class CalculateDeviation: MonoBehaviour{
  private Transform transform;
  void Start ( ) {
    transform = gameObject, GetComponent<Transform>( );
    float deviation = CalculateXDeviation( );
    Debug. Log(“coordinate difference of X is:” + deviation);
  }
  private float CalculateXDeviation( ){
    float currentX = transform. position. x;
    float targetX = 10.0f;
    float deviation = targetX − currentX;
    return deviation;
  }
}
```

In addition to the above method, the method disclosed herein can also work out the initially-calculated propulsion control quantity by using a quaternion method instead of the above method.

Step 502: Floor segmentation: obtaining, based on the initially calculated propulsion control quantity and the physical behavior-based coal seam floor update model predicted in step 204, floor data corresponding to the propelling section of the scraper conveyor and propelling trajectory information of each section of line pan of the propelling section of the scraper conveyor; establishing, based on the floor data, a floor function Z=F(x, y, z) corresponding to a propelling trajectory of each section of line pan in the propelling section of the scraper conveyor, and finding an extreme point of the floor function; letting

$$\frac{\partial F}{\partial x} = 0 , \frac{\partial F}{\partial y} = 0 , \frac{\partial F}{\partial z} = 0 ,$$

working out a point to possibly become an extreme point, and determining whether the point is an extreme point; finally determining the extreme point of the coal seam floor corresponding to the propelling trajectory of each section of line pan in the propelling section of the scraper conveyor; segmenting the coal seam floor in the propelling direction of the propelling section of the scraper conveyor based on the determined extreme point, and at the same time, segmenting the propelling trajectory of each section of line pan in the propelling section of the scraper conveyor by using an optimized discretization method based on the corresponding extreme point, where the optimized discretization method is an existing well-known method, and means a method for discretizing an independent variable and a target variable that are linked together; the target variable in the method of the present disclosure is a coordinate change ΔX of the propulsion control quantity in the propelling direction, and the independent variable is an X coordinate value of the coal seam floor.

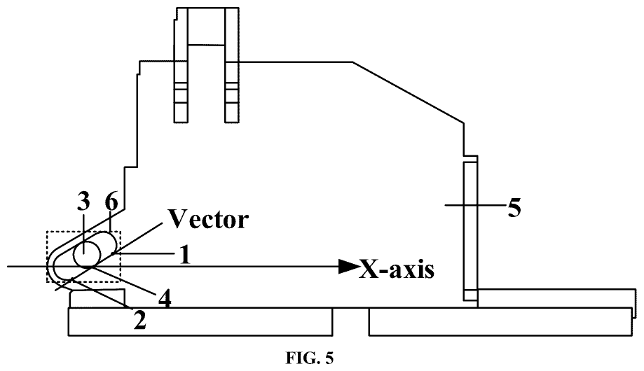

Step 503: Performing simulation in Unity3D software to find a real-time advancing position of each section of line pan of the scraper conveyor: establishing a coordinate system based on the advancing mechanism between the scraper conveyor and the hydraulic support, using the propelling direction of the scraper conveyor as an X-axis direction, as shown in FIG. 5, selecting two points on a advancing lug hole 6 on each section of line pan 5 of the scraper conveyor as key points 1 and 2, where the two points are located on the same side as the scraper conveyor, and obtaining pose information of the two key points 1 and 2, so as to obtain a piece of vector information corresponding to the line pan; performing deduction based on a floating connection mechanism model in an advancing mechanism to deduce coordinates of a contact point 4 in the X-axis direction, where the contact point is a point of contact between a connector pin 3 of a floating connection mechanism and the advancing lug hole in an advancing process; calculating position information of the contact point based on the vector information; and finally, calculating a real-time advancing position of each section of line pan of the scraper conveyor based on the physical behavior-based coal seam floor update model predicted in step 204 and the equipment pose information obtained by the mining face information processing model.

Step 504: Performing simulation in the Unity3D software to complete a propelling operation of an S-shaped curved section of the scraper conveyor: using an existing curved section length calculation method to deduce a section of line pan, in which the propelling section of the scraper conveyor is located, in the S-shaped curved section, and determining the number of sections of line pan before the deduced section and the number of sections of line pan after the deduced section in the curved section (that is, separating a previous curved section from a current curved section); establishing a parent-child relationship of the line pan in the Unity3D software, and setting a limit—that is, a maximum curvature of each section of line pan, and then deducing a required advancing amount of each section of line pan of the corresponding form in the scraper conveyor, and executing a propelling operation of the S-shaped curved section of the scraper conveyor in the Unity3D software.

In this embodiment, a process of establishing a parent-child relationship of the line pan is: adding five key point pins onto the line pan: a lower right pin, an upper right pin, a lower left pin, an upper left pin, and a middle pin. For the line pan at the first half of the curved section, the lower right pin is used as a parent object, and the coordinates of the line pan are the coordinates of the previous lower left pin, and are rotated one degree around the pin. The line pan at the last half uses the upper right pin as a parent object, and the coordinates of the line pan are the coordinates of the previous upper left pin, and are rotated one degree around the pin. When a next line pan is propelled, each line pan changes to the position of the previous line pan in turn. This part of technical content has been disclosed in the prior art.

Step 505: Control quantity screening step: outputting, based on the propelling simulation performed in the Unity3D software in the steps 501-504, segmentation information indicating that a section of line pan of the scraper conveyor fails to complete propelling in the entire advancing process; and determining whether a section fails to complete propelling among all sections of line pans of the scraper conveyor at each moment of the propelling process; eliminating corresponding line pan propulsion control quantity information once a section fails to complete propelling, and repeating the above operations until the segmentation information indicating that each section of line pan in the propelling section of the scraper conveyor successfully completes propelling is obtained and the corresponding line pan propulsion control quantity information is obtained.

Step 506: Constructing a cost function to find a theoretical minimum value: selecting floor feature points based on the floor segmentation in step 502, and constructing the following cost function:

$$J = α {\int }_{0}^{t} {( x ( t ) - {x}_{t} arg et )}^{2} d t + β {\int }_{0}^{t} {u ( t )}^{2} d t \qquad Formula ( 1 )$$

In the formula above, x(t) is a current position of the scraper conveyor; xₜarget is a position of a start point (that is, a segmentation point between two sections) of a corresponding section of the floor; t is a time spent by the scraper conveyor in being propelled to travel the corresponding section of the floor; u(t)² is an acting force of a propelling cylinder in the propelling process; α and β are proportions of a position cost and a behavior cost respectively, satisfying: ≢=0.7 and β=0.3 because this method focuses on control quantities in the process.

Calculating a theoretical minimum value based on the cost function represented by Formula (1) and based on the propulsion control quantity initially calculated in step 501.

Step 507: Selection of an optimal propulsion control quantity: calculating the cost function under different conditions of a propulsion distance and a propulsion force based on the line pan propulsion control quantity obtained in step 505 and the cost function constructed in step 506, and comparing the cost function with the theoretical minimum value to determine whether the minimum value is reached (that is, the cost function is less than or equal to the minimum value); directly deriving the corresponding line pan propulsion control quantity as an optimal propulsion control quantity when the minimum value is reached, or, re-segmenting the coal seam floor based on the extreme point in step 502 when the minimum value is not reached; adjusting a position of a segmentation point based on the extreme point, and translating toward a start point of propelling to complete re-segmentation; adjusting, based on the re-segmentation of the coal seam floor, the propulsion distance and the propulsion force of the propelling section of the scraper conveyor, repeating the simulation and determining in the steps 502, 505, and 506 in the Unity3D software, and keeping adjustment and optimization until the cost function reaches the minimum value.

Step 508: Formulating an optimal propelling strategy: formulating the optimal propelling strategy based on the optimal propulsion control quantity obtained in step 507; and transmitting the optimal propelling strategy to the feedback control model of the execution space.

What is claimed is:

1. A scraper conveyor straightening method based on a rolling time-domain control concept, comprising the following spaces: an execution space containing a feedback control model, a deduction space containing a mining face information processing model, and a prediction space containing a coupled floor update model, a baseline prediction model, a spatial difference feedback model, and a control quantity optimization model, wherein the method comprises:
receiving, by the feedback control model of the execution space, an optimal propelling strategy of a scraper conveyor finally determined by the prediction space; controlling, by an electro-hydraulic control system, a subsequent propelling operation on the scraper conveyor based on the optimal propelling strategy, so as to achieve a purpose of straightening the scraper conveyor; and at the same time, feeding back real-time mining face information to the mining face information processing model of the deduction space;
deducing and back-calculating, by the mining face information processing model in the deduction space, the real-time mining face information fed back by the execution space feedback control model that has been run, and sending the deduced information to the prediction space, wherein the real-time mining face information comprises pose information of three fully-mechanized mining machines, cutting information of a coal mining machine, and coal seam floor information;
receiving, by the prediction space, the deduced information of the deduction space, and performing simulated prediction to finally determine an optimal propelling strategy of the scraper conveyor, wherein the coupled floor update model constructs a virtual known coal seam floor based on the deduced information, establishes a coupling relationship between fully-mechanized mining equipment and the coal seam floor, and finally predicts and updates a coal seam floor model of a to-be-mined region;
simulating, by the baseline prediction model, a scraper conveyor propelling process based on the coupled floor update model, predicting a scraper conveyor baseline after a propelling operation, and providing a calculation basis for the subsequent spatial difference feedback model and the control quantity optimization model;
providing, by the spatial difference feedback model, correction data for equipment pose adjustment of the subsequent control quantity optimization model, wherein the spatial difference means a spatial difference between actual pose information of the scraper conveyor after a current propelling operation and a post-propelling scraper conveyor baseline previously predicted by the baseline prediction model; and
obtaining, by the control quantity optimization model, the optimal propelling strategy based on the coupled floor update model, the baseline prediction model, and the spatial difference feedback model, and providing the optimal propelling strategy to the feedback control model of the execution space.

2. The scraper conveyor straightening method based on a rolling time-domain control concept according to claim 1, wherein the mining face information processing model obtains the pose information of the three fully-mechanized mining machines according to the following specific process:
step 101: a step of obtaining pose information of a hydraulic support group: installing a three-dimensional lidar at a middle position of a body of the coal mining machine and scanning the hydraulic support group along with a cutting process of the coal mining machine; using a pin that connects a base and an advancing cylinder on the hydraulic support and one vertex position at a junction between a top beam and a guard plate as characteristic positions, obtaining point cloud data of the two characteristic positions, and performing filtering, segmentation, and registration operations; and deducing the resultant point cloud data that is relatively accurate, and finally obtaining the pose information of the hydraulic support group;
step 102: a step of obtaining the pose information of the scraper conveyor: obtaining data of a strapdown inertial navigation system on the coal mining machine; eliminating a cumulative error of the strapdown inertial navigation system by using an extended Kalman filter method, and obtaining accurate position information of the coal mining machine; back-calculating a trajectory of the scraper conveyor by use of the position information of the coal mining machine based on a position relationship between the scraper conveyor and the coal mining machine; and selecting a key point on each section of line pan of the scraper conveyor, and deducing the pose information of the scraper conveyor by using the key point, wherein the key point is typically a center point of each section of line pan of the scraper conveyor and no special requirement is imposed on selection of the key point; and
step 103: data processing step: eliminating abnormal values in the pose information obtained in the step 101 and the step 102; quantizing and storing information data to facilitate subsequent information deduction and update operations.

3. The scraper conveyor straightening method based on a rolling time-domain control concept according to claim 1, wherein a specific construction process of the coupled floor update model is:
step 201: constructing a virtual coal seam floor: constructing the virtual coal seam floor based on known coal seam floor information obtained by the mining face information processing model, and constructing the virtual coal seam floor by using a Mesh component in Unity3D software;
step 202: constructing a coupled relationship model between the virtual coal seam floor and an equipment model: importing the equipment model into the Unity3D software, and setting relevant rigid body components for the equipment model; and adjusting position parameters of the equipment model so that the equipment model is in close fit with the virtual coal seam floor, so as to complete construction of a coupling relationship model between the virtual coal seam floor and the equipment model, wherein the equipment comprises a coal mining machine, a hydraulic support group, and a scraper conveyor;
step 203: predicting a corresponding coal seam floor correction model after the scraper conveyor is propelled: predicting, by using a deep long short-term memory (LSTM) neural network method based on the coal mining machine cutting information obtained by the mining face information processing model and based on coal drop information of the coal mining machine in past cutting processes, the corresponding coal seam floor correction model after the scraper conveyor is propelled;
step 204: predicting a physical behavior-based coal seam floor update model: setting a scraper conveyor propelling amount based on the coupling relationship model of step 202 and the coal seam floor correction model of step 203, running Unity3D software to simulate a propelling operation of the scraper conveyor, applying speeded up robust features (SURF) algorithm to extract feature point information of the coal seam floor corresponding to a propelling section of the scraper conveyor after the scraper conveyor is propelled, and reconstructing a corresponding coal seam floor after the scraper conveyor is propelled, so as to obtain a reconstructed coal seam floor model; analyzing, based on the reconstructed coal seam floor model, pit and loose coal pile damage caused by a propelling behavior of the scraper conveyor to the coal seam floor, performing stress analysis, and obtaining, based on the Mohr-Coulomb criterion, a proof of damage caused to the floor after the scraper conveyor is propelled; performing numerical value simulation analysis on the reconstructed coal seam floor model by using FLAC3D software based on the proof of damage to the floor, and calculating a maximum damage depth and position of the coal seam floor caused by a force along a propelling direction of the scraper conveyor and a lateral support pressure under a stress model; and finally, constructing a physical behavior-based coal seam floor update model by using the Mesh component in the Unity3D software based on the reconstructed coal seam floor model and results of the maximum damage depth and position.

4. The scraper conveyor straightening method based on a rolling time-domain control concept according to claim 1, wherein a specific construction process of the baseline prediction model is:
step 301: expressing position information of a key point in each section of line pan of the scraper conveyor at a current cut based on a primary coordinate system, wherein the key point in the line pan is typically a center point of each section of line pan of the scraper conveyor and no special requirement is imposed on selection of the key point in the line pan;
step 302: comparing coordinate information of each section of line pan in the propelling direction of the scraper conveyor, determining a most lagging section of line pan, and recording a serial number i of the most lagging section of line pan;
step 303: establishing a parallel system in the Unity3D software based on the coal seam floor update model to simulate a propelling process of the scraper conveyor, and obtaining position information of the most lagging section of line pan that has been advanced for a full stroke;
step 304: selecting n position points evenly in the entire advancing stroke of the most lagging section of line pan, numbering the n position points from 1 to n in a direction from a start to an end of advancing, and obtaining position information of each position point;
step 305: simulating the propelling process of remaining line pans of the scraper conveyor in the parallel system by using a position line corresponding to the position point n as an end point of the advancing stroke, and determining whether the key points of all the remaining line pans reach the position line corresponding to the position point n; using the position line as a predicted baseline of the propelled scraper conveyor when all the remaining line pans reach the position line; or, selecting, when any one of the remaining line pans fails to reach the position line, a position line corresponding to a previous position point as an end point of the advancing stroke; and repeating the above simulation and determining process until the key points of all the remaining line pans of the scraper conveyor reach the end point of the advancing stroke.

5. The scraper conveyor straightening method based on a rolling time-domain control concept according to claim 1, wherein the spatial difference feedback model is formed of three parts: a feedforward space, a feedback space, and a correction mechanism, and a specific construction process of the spatial difference feedback model is:
step 401: feedforward space: extracting prediction rules in a prediction process based on a past process of predicting a baseline of the propelled scraper conveyor by the baseline prediction model, deducing possible situations, and taking corresponding measures to eliminate possible deviations in advance;
step 402: feedback space: calculating a spatial difference based on the baseline of the propelled scraper conveyor predicted by the baseline prediction model and actual pose information of the propelled scraper conveyor;
step 403: correction mechanism: applying data information, obtained from the feedforward space and the feedback space, to a feedforward space prediction process by using a relevant coefficient, so as to obtain a corrected prediction result; monitoring the feedback data continuously, and making adjustments based on real-time feedback information; and iterating and optimizing the correction mechanism continuously based on feedback results of an actual operation.

6. The scraper conveyor straightening method based on a rolling time-domain control concept according to claim 1, wherein a specific construction process of the control quantity optimization model is:
step 501: obtaining an initially calculated propulsion control quantity: obtaining, by the mining face information processing model, pose information of the scraper conveyor in a current propelling section; predicting, by the baseline prediction model, a scraper conveyor baseline after a current propulsion of the scraper conveyor; and then correcting, based on a spatial difference obtained by the spatial difference feedback model, the predicted scraper conveyor baseline after the current propulsion of the scraper conveyor; and obtaining the initially calculated propulsion control quantity by calculating a difference between the corrected baseline of the scraper conveyor and pose information of the scraper conveyor in the current propelling section;
step 502: floor segmentation: obtaining, based on the initially calculated propulsion control quantity and the physical behavior-based coal seam floor update model predicted in step 204, floor data corresponding to the propelling section of the scraper conveyor and propelling trajectory information of each section of line pan of the propelling section of the scraper conveyor; establishing, based on the floor data, a floor function Z=F(x, y, z) corresponding to a propelling trajectory of each section of line pan in the propelling section of the scraper conveyor, and finding an extreme point of the floor function; letting
$$\frac{\partial F}{\partial x} = 0 , \frac{\partial F}{\partial y} = 0 , \frac{\partial F}{\partial z} = 0 ,$$
working out a point to possibly become an extreme point, and determining whether the point is an extreme point; finally determining the extreme point of the coal seam floor corresponding to the propelling trajectory of each section of line pan in the propelling section of the scraper conveyor; segmenting the coal seam floor in the propelling direction of the propelling section of the scraper conveyor based on the determined extreme point, and at the same time, segmenting the propelling trajectory of each section of line pan in the propelling section of the scraper conveyor by using an optimized discretization method based on the corresponding extreme point;
step 503: performing simulation in Unity3D software to find a real-time advancing position of each section of line pan of the scraper conveyor: establishing a coordinate system based on the advancing mechanism between the scraper conveyor and the hydraulic support, using the propelling direction of the scraper conveyor as an X-axis direction, selecting two points on a advancing lug hole (6) on each section of line pan (5) of the scraper conveyor as key points (1) and (2), wherein the two points are located on the same side as the scraper conveyor, and obtaining pose information of the two key points (1) and (2), so as to obtain a piece of vector information corresponding to the line pan; performing deduction based on a floating connection mechanism model in an advancing mechanism to deduce coordinates of a contact point (4) in the X-axis direction, wherein the contact point is a point of contact between a connector pin (3) of a floating connection mechanism and the advancing lug hole in an advancing process; calculating position information of the contact point based on the vector information; and finally, calculating a real-time advancing position of each section of line pan of the scraper conveyor based on the physical behavior-based coal seam floor update model predicted in step 204 and the equipment pose information obtained by the mining face information processing model;
step 504: performing simulation in the Unity3D software to complete a propelling operation of an S-shaped curved section of the scraper conveyor: using an existing curved section length calculation method to deduce a section of line pan, in which the propelling section of the scraper conveyor is located, in the S-shaped curved section, and determining a number of sections of line pan before the deduced section and a number of sections of line pan after the deduced section in the curved section; establishing a parent-child relationship of the line pan in the Unity3D software, and setting a limit—that is, a maximum curvature of each section of line pan, and then deducing a required advancing amount of each section of line pan of the corresponding form in the scraper conveyor, and executing a propelling operation of the S-shaped curved section of the scraper conveyor in the Unity3D software;
step 505: control quantity screening step: outputting, based on the propelling simulation performed in the Unity3D software in the steps 501-504, segmentation information indicating that a section of line pan of the scraper conveyor fails to complete propelling in the entire advancing process; and determining whether a section fails to complete propelling among all sections of line pans of the scraper conveyor at each moment of the propelling process; eliminating corresponding line pan propulsion control quantity information once a section fails to complete propelling, and repeating the above operations until the segmentation information indicating that each section of line pan in the propelling section of the scraper conveyor successfully completes propelling is obtained and the corresponding line pan propulsion control quantity information is obtained;
step 506: constructing a cost function to find a theoretical minimum value: selecting floor feature points based on the floor segmentation in step 502, and constructing the following cost function:
$$J = α {\int }_{0}^{t} {( x ( t ) - {x}_{t} arg et )}^{2} d t + β {\int }_{0}^{t} {u ( t )}^{2} dt \qquad Formula ( 1 )$$
in the formula above, x(t) is a current position of the scraper conveyor; xₜarget is a position of a start point of a corresponding section of the floor; t is a time spent by the scraper conveyor in being propelled to travel the corresponding section of the floor; u(t)² is an acting force of a propelling cylinder in the propelling process; α and β are proportions of a position cost and a behavior cost respectively, satisfying: α=0.7 and β=0.3 because this method focuses on control quantities in the process;
calculating a theoretical minimum value based on the cost function represented by Formula (1) and based on the propulsion control quantity initially calculated in step 501;
step 507: selection of an optimal propulsion control quantity: calculating the cost function under different conditions of a propulsion distance and a propulsion force based on the line pan propulsion control quantity obtained in step 505 and the cost function constructed in step 506, and comparing the cost function with the theoretical minimum value to determine whether the minimum value is reached; directly deriving the corresponding line pan propulsion control quantity as an optimal propulsion control quantity when the minimum value is reached, or, re-segmenting the coal seam floor based on the extreme point in step 502 when the minimum value is not reached; adjusting a position of a segmentation point based on the extreme point, and translating toward a start point of propelling to complete re-segmentation; adjusting, based on the re-segmentation of the coal seam floor, the propulsion distance and the propulsion force of the propelling section of the scraper conveyor, repeating the simulation and determining in the steps 502, 505, and 506 in the Unity3D software, and keeping adjustment and optimization until the cost function reaches the minimum value; and
step 508: formulating an optimal propelling strategy: formulating the optimal propelling strategy based on the optimal propulsion control quantity obtained in step 507; and transmitting the optimal propelling strategy to the feedback control model of the execution space.
